(19) United States
(12) Patent Application Publication
(10) Pub. No.: US 2025/0029513 A1
(43) Pub. Date: Jan. 23, 2025

(54) ARTIFICIAL INTELLIGENCE-DRIVEN AUTOMATED ONLINE PROCTORING SYSTEM

(71) Applicant: Silicon Valley High School Inc., Las Vegas, NV (US)

(72) Inventors: David Smith, Bellingham, WA (US); Scott Jarol, Seattle, WA (US)

(21) Appl. No.: 18/767,799

(22) Filed: Jul. 9, 2024

Related U.S. Application Data
(60) Provisional application No. 63/527,753, filed on Jul. 19, 2023.

(51) Int. Cl. G09B 7/02; G06F 3/01; G06F 11/34; G06V 40/16

(52) U.S. Cl. CPC G09B 7/02; G06F 3/013; G06F 11/3438; G06V 40/172

(57) ABSTRACT

A method for automated online proctoring, in accordance with one embodiment, includes using an AI system to consider monitored aspects of activities of a student taking a test to calculate a trust score indicative of academic integrity, the aspects including at least user interaction with one or more input devices, and eye movements of the student. The AI system is used to provide guidance to the student during the test for improving a submission input by the student during the test. An automated online proctoring system, in accordance with one embodiment, includes a facial recognition module; a lockdown test monitor module; and an AI system configured to consider a plurality of monitored aspects of activities of the student to calculate a trust score that characterizes an authenticity and originality of a submission by the student during the test, and to provide guidance to the student during the test.

### RELATED APPLICATIONS

This application claims priority to U.S. Provisional Appl. No. 63/527,753, filed Jul. 19, 2023, which is herein incorporated by reference.

### FIELD OF THE INVENTION

The present invention relates to digital education such as online learning and online examination, and more particularly, this invention relates to an innovative system designed to bolster academic integrity and deter malpractices during online examinations and assignments, using artificial intelligence (AI). The system may also embed intelligent tutoring capabilities to improve the overall learning experience.

### BACKGROUND

The digital transformation of the educational sector, though being a significant boon to universal access to education, has simultaneously posed notable challenges. Among these, ensuring academic integrity and the legitimacy of students' work in remote learning environments has become paramount. Contemporary online proctoring solutions offer limited efficacy, thereby underscoring the necessity for an evolved, comprehensive system that amalgamates robust verification of academic honesty with facilitating a conducive learning environment.

Moreover, in the rapidly evolving landscape of digital education, traditional online proctoring solutions often fall short in providing comprehensive support to students who struggle with initiating and structuring their written work. which can inadvertently drive them towards academic dishonesty.

### SUMMARY

A method for automated online proctoring, in accordance with one embodiment, includes using an AI system to consider monitored aspects of activities of a student taking a test to calculate a trust score indicative of academic integrity, the aspects including at least user interaction with one or more input devices, and eye movements of the student. The AI system is used to provide guidance to the student during the test for improving a submission input by the student during the test.

An automated online proctoring system, in accordance with one embodiment, includes a facial recognition module configured to identify a human student; a lockdown test monitor module for preventing the student from viewing material outside of a test display during a test; and an AI system configured to consider a plurality of monitored aspects of activities of the student, including at least typing and eye movements, to calculate a trust score that characterizes an authenticity and originality of a submission by the student during the test. The AI system is also configured to provide guidance to the student during the test for improving a submission input by the student during the test.

A computer program product, in accordance with one embodiment, includes a computer readable storage medium having stored thereon program instructions for causing a computer to perform the foregoing method.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1 is a flowchart of a method, in accordance with one embodiment of the present invention.

FIG. 2 is a diagram of a computing environment, in accordance with one embodiment of the present invention.

FIG. 3 is a diagram of a tiered data storage system, in accordance with one embodiment of the present invention.

FIG. 4 depicts a system, in accordance with one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

Various aspects of the present invention pertain to a state-of-the-art, artificial intelligence (AI)-powered online proctoring system, offering a novel solution for ensuring academic integrity in digital education environments. In one approach, the system employs multiple layers of verification and monitoring to deter academic malpractices. Exemplary components, according to a preferred embodiment, include a collection of features selected from the group consisting of a lockdown test monitor, a proprietary AI-monitored text editor, type-based signature recognition, AI-assisted learning, eye movement tracking, and a suspicious activity detection mechanism. The system may employ one or more AI algorithms trained to scrutinize various aspects of a student's activities such as typing, mouse movements, and eye movements, enabling the system to discern between authentic academic behavior and potential violations. In one aspect, the system provides a visual “Trust Score” to indicate the level of credibility associated with a student's actions. Additionally, in some approaches, an integrated AI assistant may be used to enhance the learning experience by offering constructive feedback and guidance. The resulting comprehensive system effectively blends strict proctoring with supportive learning, serving to advance the field of online education and assessment. More details are provided below.

In one general embodiment, a method for automated online proctoring, in accordance with one embodiment, includes using an AI system to consider monitored aspects of activities of a student taking a test to calculate a trust score indicative of academic integrity, the aspects including at least user interaction with one or more input devices, and eye movements of the student. The AI system is used to provide guidance to the student during the test for improving a submission input by the student during the test.

In another general embodiment, an automated online proctoring system includes a facial recognition module configured to identify a human student; a lockdown test monitor module for preventing the student from viewing material outside of a test display during a test; and an AI system configured to consider a plurality of monitored aspects of activities of the student, including at least typing and eye movements, to calculate a trust score that characterizes an authenticity and originality of a submission by the student during the test. The AI system is also configured to provide guidance to the student during the test for improving a submission input by the student during the test.

In yet another general embodiment, a computer program product includes a computer readable storage medium having stored thereon program instructions for causing a computer to perform the foregoing method.

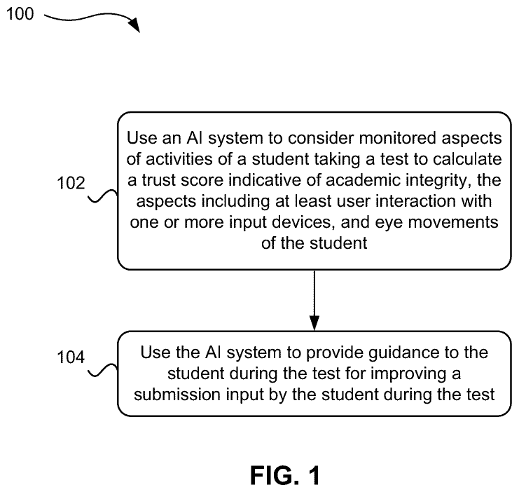

FIG. 1 shows a method 100 for automated online proctoring, in accordance with one embodiment. As an option, the present method 100 may be implemented using devices, and to perform functionality, such as those shown in the other FIGS. described herein. Moreover, the present method 100 may include any desired combination of features disclosed herein, including one or more features from the sections below entitled “Exemplary AI-powered systems for automated online proctoring” and “Exemplary enhanced smart editor systems.” Of course, however, this method 100 and others presented herein may provide features which may or may not be related to the illustrative embodiments listed herein. Further, the methods presented herein may be carried out in any desired environment. Moreover, more or less operations than those shown in FIG. 1 may be included in method 100, according to various embodiments. It should also be noted that any of the aforementioned features may be used in any of the embodiments described in accordance with the various methods.

In operation 102, an AI system is used to consider monitored aspects of activities of a student taking a test to calculate a trust score indicative of academic integrity, the aspects including at least user interaction with one or more input devices, and eye movements of the student.

In operation 104, the AI system is used to provide guidance to the student during the test for improving a submission input by the student during the test.

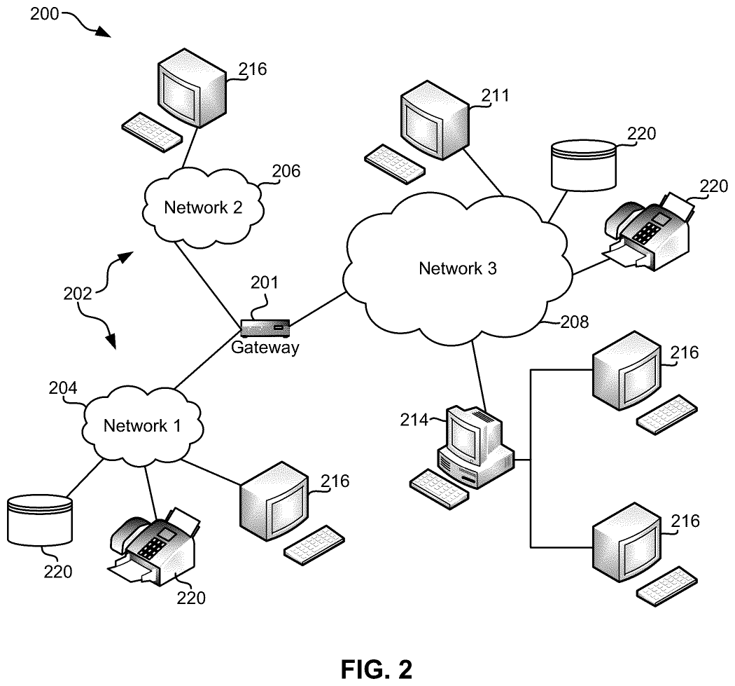

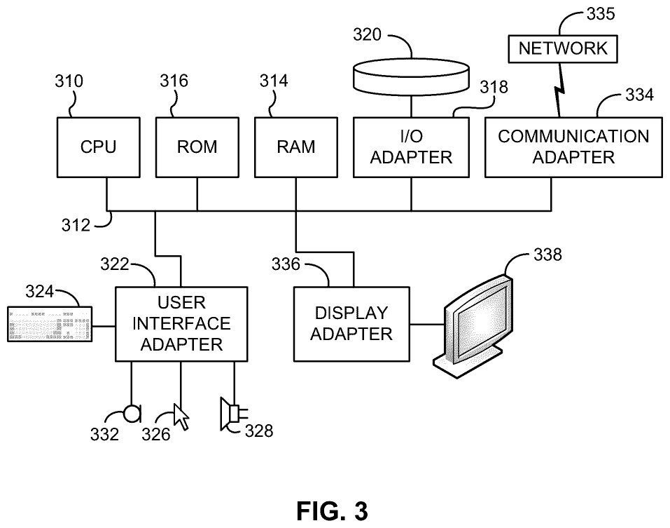

The AI system may have at least one AI model trained to perform a respective portion or all of the functionality disclosed herein. The AI system may also include hardware components, such as a computer for running the AI modules such as a server, network server, etc., and/or particular hardware and/or software modules of said computer; a computer on which the test is taken and/or particular hardware and/or software modules of said computer; etc. See, e.g., FIGS. 2-3, which are described in more detail below. Accordingly, an AI system may have multiple AI modules that provide independent, overlapping, cooperating, and/or pipelined functionality. For example, one AI model may be used to perform a particular function, such as eye movement tracking, while another AI model performs the functions to generate the guidance. Moreover, an AI system may include a computer that runs the AI model(s), where said computer is in communication with the computer on which the test is being taken, e.g., via a network.

Any known AI platform or set of platforms may be used, and integrated to create the automated online proctoring system that implements the method 100.

Each AI model used in various approaches may be trained on predefined training data according to known training techniques to enable the AI model to provide the corresponding functionality. The AI training data may be any data suitable for training the corresponding AI model for its intended purpose, as would become apparent to one skilled in the art after reading the present disclosure.

Preferably, some of the outputs of each AI model are reviewed by a human for correctness, the data with corrected labels, and/or updated training data generated based on the human review, is fed back into the AI model as training data to improve the accuracy of the AI model. The outputs be reviewed can be chosen according to any known technique, such as randomly, periodically, based on a confidence score, etc.

The AI model(s) may be used, at least in part, as part of the overall AI system to provide some or all of the features described below in the sections below entitled “Exemplary AI-powered systems for automated online proctoring” and “Exemplary enhanced smart editor systems.” For example, an AI model may be trained, in a manner that would become apparent to one skilled in the art after reading the present disclosure, and used, possibly with other software modules, to provide a particular feature or function as described in said sections.

The method 100 of FIG. 1 may be performed as a client-server application. In one approach, backend services are hosted by an extant cloud-based provider, such as Amazon Web Services (AWS) for scalability and reliability.

Machine learning models undergo rigorous development, testing, and validation phases to ensure accuracy and reliability in detecting academic misconduct. Training data, labeled by educators, are used to refine and improve the models continuously. The integration of AI models, such as GPT-4 or the like, further enhances the system's capabilities in providing personalized assistance and feedback to students. Various exemplary embodiments will now be described.

In one embodiment, the AI system monitors acoustic data of a test-taking environment to detect indication that the student is receiving guidance from a source of audio information such as another person, a telephone, etc. For example, in one approach, the AI system monitors the audio as detected (e.g., by one or more microphones built into the student's computing device), as a student takes a test, listening to the keyboard and mouse activity and detecting if the student is listening to another person or external source of audio information. In another approach, some or all features of the Audio Device Tracker and/or Screen-Locking and Audio Detection module described below may be used.

In one embodiment, the AI system performs linguistic analysis on the student's submission to evaluate a coherence and quality of written content in the submission, and provides real-time feedback such as corrections, suggestions, etc. for improving the submission to the student. In one example, for feedback to the user on the quality of their work, distinct from academic integrity, the text is submitted periodically to an existing, publicly available large language model (LLM), a type of Artificial Intelligence (AI) system typically based on neural network technology and trained on large volumes of publicly available data. The student's work is sampled as they complete it and submitted to the LLM, which is also provided, in the accepted “prompting” methodology, with instructions detailing how to evaluate the student's work, such as evaluating for consistency with other parts of the document, clarity, sentence structure, grammar, continuity, factual correctness, and compliance with the assigned form and length, such as a five paragraph essay, research paper, book report, or other types of compositions.

See the section entitled “Exemplary enhanced smart editor systems,” below for more details that may be included in this feature.

In one embodiment, facial recognition software of a type known in the art is used in a manner known in the art to identify a student. See, e.g., the PhotoID feature described below. A camera, e.g., webcam, integrated camera, etc. on or coupled to a computer, e.g., personal computer, phone, tablet, etc., being used by the student may be used to view the student. Again, for this and other modules that may capture input, images, sound, and/or personal information about the student, permission to use the camera, microphone, etc. of the computer is preferably obtained prior to enabling the respective feature. In one approach, known facial recognition technology, e.g., such as one that is commercially available, one that is available as open-source software, etc., is incorporated into the proctoring system using such existing program code and related machine learning models needed to record and further identify individual user's faces.

In another embodiment, output to a computer screen (e.g., output to be displayed on a computer monitor, tablet, etc.) is screen-locked to prevent the student from using material outside a test display. In one approach, the graphical portion of the display output having the test, e.g., a window having the test, is locked so that other windows cannot be viewed. In another approach, the entire screen of a device displaying the test to the student may be locked. In a further approach, screen-locking may simply detect selection of a second window, that is not a window showing the test. In another approach, this feature may include some or all of the features of the Lockdown Test Monitor and/or the Screen-Locking and Audio Detection module described below.

In one embodiment, academic records of the student are analyzed for generating personalized recommendations to educator(s) (or equivalently, other person(s) associated with the test), based on a historical performance and writing proficiency of the student. In one approach, some or all of the features of the Academic Record Integration described below may be used.

In one embodiment, the guidance provided by operation 104 of FIG. 1 includes suggestions for language formulation and how to improve a structure and content of the submission, e.g., to assist the student in achieving a higher test score. In one approach, some or all of the features of the Language Usage Analysis feature described below may be provided.

In one embodiment, the work in progress is submitted periodically, e.g., based either on text units such as paragraphs, or at predetermined time intervals, to a trained machine learning model. This AI system may thus observe the construction of the student's submission during the test or assignment, and track an evolution of the submission over time to determine whether the submission appears to be transcribed or copied from an alternate source. For example, the AI system may observe the student's submission in real time to determine whether the process adheres to a natural progression of an authentic submission. In one approach, a natural progression may generally refer to entry of text that follows a natural flow, with similar grammar and wording as previously-written text, continuity of thought, continuity of subject matter, etc. If text is suddenly entered that uses nouns, verbs, adjectives, etc. that are different than those previously used, or deemed unusual in light of the prior writing, such text may be deemed suspect, e.g., indicative of derivation from a source other than the student. If an anomaly is detected, the submission may be flagged as potentially transcribed or copied from another source. The method of analysis may be embodied in existing, publicly available large language models, from which an evaluation may be requested by means of proprietary instructions known as prompts, along with student historical data.

In one approach, the method 100 also includes detecting a reference to external material in the student's input during the test. In response to detecting the reference, a prompt requesting a source URL of the reference is output. Equivalently, other identifying information such as a title, author, publication name, etc. may be requested and/or received. A citation in a standardized citation format is generated based on information derived using the URL or other identifying information. In one approach, the citation is obtained by locating the online source specified by the student and then verifying that the source contains the cited information, and by capturing details necessary for citation, such as publisher, author, and/or other details furnished by the host website. The details may be sent to a publicly available large language model (LLM) for formatting into any one of the standard academic reference formats, such as APA, Chicago, etc. Preferably, the citation is output to the student for inclusion in the student's writings. In another approach, the citation is automatically added to the student's writings. In yet another approach, some or all of the functionality of the Citation Management module described below may be used.

In one approach, the AI system is used to provide a behavioral reminder encouraging ethical writing practice. Such reminders may be output according to any predefined criteria, such as periodically, in response to detecting some triggering factor such as detection of potential misbehavior, etc. In one approach, some or all of the functionality of the Behavioral Reminders module described below may be used.

In one approach, an adjacent interface to a second AI system is provided for output on a display viewed by the student during the test. The interface is configured to receive input from the student for input to the second AI system. For example, the input may include a query input by the user, a request for a citation, etc. In some approaches, the second AI system is completely external to the instant AI system that is assisting with proctoring the exam, e.g., is a third party AI system. After the results are processed by the second AI system, results from the second AI system are output to the student. In some approaches, some or all of the features of the AI Assistance module described below may be provided. The AI assistance, known generally as AI chat, may be provided by submitting student requests to a publicly available large language model, and then displaying the response within the interface presented adjacent to the assignment editor.

In one approach, operation 102 of the method 100 of FIG. 1 includes tracking eye movements for detecting when the student consults an information source (such as another screen, device, book, etc.) outside of the test display. Moreover, in this approach, the AI system considers a plurality of monitored aspects of activities of the student, including at least typing, mouse movements, and the eye movements, to calculate a trust score that characterizes an authenticity and originality of a submission by the student during the test. In some approaches, some or all of the features of the Trust Score module described below may be provided. In some approaches, eye-tracking functionality may be seamlessly integrated into a web-based editor using a JavaScript library, facilitating real-time data collection and analysis. A self-calibrating process may be used to ensure accurate eye-tracking measurements, enhancing the system's effectiveness in monitoring student behavior.

A “student” as used herein is meant to refer to any human inputting information into any type of computer (such as a personal computer, tablet, smart phone, kiosk, etc.) that is implemented in conjunction with any of the various embodiments described herein. Thus, a student may be a true student such as a test taker taking a test associated with schooling, a test taker taking a written motor vehicle test, a professional taking an accreditation test, a consumer taking an online test for some purpose, etc. However, a “student” as used herein may also refer to a human entering other types of input in association with other activities than testing, such as survey takers, civilians entering data in a report, etc. Thus, while much of the present description refers to “tests,” it should be understood that this is done by way of example only, and the various embodiments have applicability to a broad range of computerized activities not strictly limited to academic or professional testing, but may apply to any other online entry of information such as homework; adding information to surveys, police reports, accident reports, online claims forms, etc.

It should be noted that, in embodiments and approaches described herein, any capture and/or use of images/video, sound, data input, user information, etc. is preferably only captured and used subsequent to a user granting permission for such data/information to be captured and/or used. More specifically, this permission is preferably obtained in such a way that the user has the opportunity to consider and review details of how their information will be used (to assist the user in making an informed decision), and thereafter presented with an option to opt-in, e.g., an expressly performed opt-in selection. Thereafter, the user is preferably reminded of their opt-in, and ongoingly presented with features, e.g., output for display on a user device associated with the user, that relatively easily allows the user to retract their previous election to opt-in. Note that these features may be presented to the user in any one or more formats, e.g., audibly, visually, braille, in multiple languages, etc. For example, the user may be presented with an unambiguous opt-out selection feature which, if elected by the user, terminates collection and use of data associated with the user, erases previously used data associated with the user, and notifies the user of the course of action taken to respect the user's selection of the opt-out feature. In the event that the user does not want to have their data used in one or more of the operations described herein, this decision is respected, and the user is preferably not again presented with such an option unless the user thereafter requests to reconsider the opt-in feature, e.g., based on a change in their decision.

### Exemplary AI-Powered Systems for Automated Online Proctoring

A sophisticated automated online proctoring system, in accordance with one embodiment, leverages the capabilities of AI to scrutinize and verify the authenticity of students' academic endeavors. Moreover, some approaches offer supportive learning aids. In yet further embodiments, a system may employ one or more of an array of measures, including but not limited to: locked-down testing mode, a unique text editor, type-based signature recognition, AI tutoring, and eye movement tracking to differentiate between genuine academic activities and potential transgressions. Moreover, one approach presents an intuitive interface that signifies the reliability of students' actions through a Trust Score.

Described herein are various embodiments of a comprehensive, preferably webcam-enabled, AI-powered system for automated online proctoring, designed to enhance academic integrity and the overall learning experience in digital education and assessment environments. A noncomprehensive list of features follows. Various embodiments employ such features, in any possible combination. Moreover, the exemplary embodiments provided in this section may include any desired combination of features disclosed herein, including one or more features from the section below entitled “Exemplary enhanced smart editor systems.”

Lockdown Test Monitor (LTM): The LTM component is activated upon the initiation of a test or exam. Once activated, it ensures that the student's display is solely dedicated to the test materials, thereby preventing access to and visibility of any other window or screen. The LTM enforces a focused and distraction-free test environment and maintains a singular point of attention for the student.

Proprietary Text Editor (PTE): The PTE is a specialized text editor designed exclusively for the input of student responses during tests. The PTE is fortified by an AI assistant, which continuously monitors all student activities within the editor. The PTE prevents conventional text copying or pasting actions, thereby ensuring the originality of student work. Furthermore, it records the sequence and timing of the student's keystrokes, contributing to a robust dataset for subsequent analysis.

Typed Signature Recognition (TSR): The TSR functionality analyses and learns the distinctive typing style of the student across all interactions with the learning management system. It generates a unique “typed signature” that represents the student's typing behavior. The TSR flags any deviations from the established typing pattern, which may suggest an anomaly or potential impersonation attempt, thereby further ensuring the legitimacy of the student's work. In exemplary approaches, the TSR may be based either on rules, such as monitoring for significant deviations from a student's typical typing speed or frequency of edits and corrections, and/or may be based on an appropriately trained machine learning model, e.g., one that takes frequency information to detect a broader range of behaviors than can be captured in a simple rules-based system.

AI-Assisted Learning (AAL): The AAL component is an AI assistant programmed to provide real-time support to the student. It offers suggestions for improvement, guidance, and constructive feedback throughout the process of constructing responses. It enhances the learning experience while discouraging academic dishonesty. For feedback to the user on the quality of their work, distinct from academic integrity, in one approach, the text may be submitted periodically to an existing, publicly available large language model (LLM), a type of Artificial Intelligence (AI) system typically based on neural network technology and trained on large volumes of publicly available data. The student's work may be sampled as they complete it and submitted to the LLM, which is also provided, in the accepted “prompting” methodology, with instructions detailing how to evaluate the student's work, such as evaluating for consistency with other parts of the document, clarity, sentence structure, grammar, continuity, factual correctness, and compliance with the assigned form and length, such as a five paragraph essay, research paper, book report, and/or other types of compositions.

Eye Movement Tracking (EMT): The EMT component utilizes the device's integrated camera to monitor the student's eye movements. The EMT provides insights into the student's area of focus and flags any diversion from the test screen. It helps in identifying any possible attempts to refer to unauthorized external resources during a test. For example, one approach may use an existing program code library, such as the open source package named WebGazer, with the capabilities of using a web camera to observe a user's pupils and calculate the screen position at which their gaze is focused, known as eye movement tracking, also known as eye tracking. This data may be collected many times each second to furnish a profile of how much time a user views various areas of the screen during a given interval.

Suspicious Activity Detection (SAD): The SAD is preferably an AI system, (e.g., based on a machine learning model developed using standard practices and publicly available components) trained to recognize and differentiate between standard, permissible diversions (such as checking time) and potential violations (such as consulting an unauthorized external source of information). Upon detection of a suspicious activity, the SAD sends a notification to the student and records the incident for further examination.

Audio Monitor: The AI system monitors the audio as the student takes the test, listening to the keyboard and mouse activity and detecting if the student is listening to another person or external source of audio information.

PhotoID: When enrolling in the course, a photograph of the student is collected and stored in a learning management system (PhotoID). An AI monitor checks that the person taking the test matches the PhotoID.

Trust Score (TS): The TS feature provides a real-time visual representation of the student's actions' credibility. It uses an indicator system derived from multiple parameters such as eye movement, typing behavior, and test progression. The TS helps proctors or educators get a quick understanding of the student's activities' trustworthiness. The TS may be determined by periodically submitting the work in progress to the proctoring machine learning model, discussed below, for evaluation.

Audio Device Tracker (ADT). The ADT component uses the device's integrated camera to monitor the student's ears checking if there are headphones, earbuds, hearing aids, or other devices that may be used to deliver information to the student while taking the test.

### Exemplary Enhanced Smart Editor System(s) and Component(S) Thereof

Recognizing that a root cause of academic misconduct is struggling with initiating and structuring written work, which can inadvertently drive a student toward academic dishonesty, various embodiments of the present invention introduce innovative features that go beyond conventional online proctoring methods by incorporating an AI-powered writing assistant as part of a smart editor system. This virtual writing tutor offers prompts, suggestions, and real-time feedback to help students overcome their writing challenges, develop their own ideas, and produce original, high-quality work, promoting a culture of integrity and genuine learning in the online education landscape.

The enhanced smart editor system, according to one general embodiment, comprises two primary functional elements: tutorial and proctoring, aimed at guiding students through the writing process while monitoring academic integrity. Unlike conventional proctoring methods relying on rigid rules, the system utilizes sophisticated machine learning algorithms to analyze data from eye tracking, keyboard inputs, and mouse activities. This approach enables dynamic assessment and intervention, ensuring proactive detection and prevention of plagiarism and other forms of academic misconduct. The system's architecture facilitates seamless integration with existing academic records, enabling educators to make informed decisions based on holistic student profiles.

A noncomprehensive list of features follows. Various embodiments employ some or all of such features, in any possible combination. Moreover, the exemplary embodiments provided in this section may include any desired combination of features disclosed herein, including one or more features from the section above entitled “Exemplary AI-powered systems for automated online proctoring.”

Dynamic Data Fusion: The system integrates eye-tracking data with keyboard and mouse activities, time clock intervals, acoustic signals, facial recognition, and the student's previous academic performance, offering a holistic view of student engagement and behavior during the writing process. By leveraging machine learning algorithms, the system adapts to individual writing styles and patterns, enhancing its efficacy in detecting anomalies indicative of academic dishonesty. A trained machine learning model, following generally accepted practices for such systems, and incorporating third part components, may receive this data. The trained model is then able to correlate these data streams to detect possible academic malpractice. The model may then output a result of analysis of the eye movement and other inputs. For example, the ML model may be instructed to classify the results with some indication of likelihood of malpractice. Examples may include: “Likely Assisted Writing,” “Possibly Assisted Writing,” or “Original Work.”

Academic Record Integration: Leveraging academic records, the system provides personalized recommendations to educators, based on students' historical performance and writing proficiency. This collaborative approach empowers educators to offer targeted support and guidance, ensuring students achieve their academic goals while upholding academic standards.

Language Usage Analysis: The system incorporates advanced linguistic analysis to evaluate the coherence and quality of written content. Through real-time feedback and suggestions, students are encouraged to refine their writing skills and express their ideas effectively, fostering academic growth and self-improvement.

Citation Management: The system streamlines the citation process by offering a built-in feature for quoting sources. When referencing external material, students are prompted to input the source URL, and the system generates a standardized citation format automatically. This ensures proper attribution and mitigates the risk of inadvertent plagiarism.

Behavioral Reminders: In addition to proactive detection of academic misconduct, the system provides gentle reminders to students, encouraging ethical writing practices. By fostering awareness and accountability, these reminders contribute to a positive academic environment conducive to learning and integrity.

AI Assistance: The system incorporates AI assistance powered by advanced, publicly available, large language models (LLM), typically based on the Generative Pretrained Transformer (GPT) AI methodology, such as Open AI's GPT-4 or Anthropic's Claude Opus, to offer personalized feedback and support to students. Through an intuitive interface, students can engage in a dialogue with the AI, receiving guidance and suggestions without compromising academic autonomy.

Screen-Locking and Audio Detection: To further enhance security and integrity, the system includes features such as screen-locking during assignments and potential audio detection capabilities. These features, when implemented, contribute to a robust ecosystem for academic writing and assessment.

The enhanced smart editor systems described herein represent a significant advancement in academic writing support and proctoring technology. By combining tutorial functionalities with dynamic proctoring capabilities, the system offers a comprehensive solution for promoting academic integrity and fostering student success. With its innovative features, seamless integration with existing educational platforms, and commitment to ethical writing practices, the system stands poised to transform the landscape of academic writing and assessment.

Various embodiments of the present invention incorporate an intricate blend of advanced technologies to facilitate a robust and reliable system for automated online proctoring. Each of the elements, in the various possible combinations, work in conjunction to ensure that the highest standards of academic integrity are maintained while fostering a conducive environment for effective learning. Furthermore, the processes of evaluating academic integrity and providing tutorial writing guidance are performed using two separate AI models, the machine learning model described above, and any one of many publicly available LLMs. The two separate processes occur simultaneously based on a combination of timed intervals, and document units, such as the completion of a paragraph, or the modification of an existing paragraph, the completion of the entire assignment, or an explicit request by the user for interim feedback from the LLM.

The description herein is presented to enable any person skilled in the art to make and use the invention and is provided in the context of particular applications of the invention and their requirements. Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

In particular, various embodiments of the invention discussed herein are implemented using the Internet as a means of communicating among a plurality of computer systems. One skilled in the art will recognize that the present invention is not limited to the use of the Internet as a communication medium and that alternative methods of the invention may accommodate the use of a private intranet, a Local Area Network (LAN), a Wide Area Network (WAN) or other means of communication. In addition, various combinations of wired, wireless (e.g., radio frequency) and optical communication links may be utilized.

The program environment in which one embodiment of the invention may be executed illustratively incorporates one or more general purpose computers or special-purpose devices such handheld computers. Details of such devices (e.g., processor, memory, data storage, input and output devices) are well known and are omitted for the sake of clarity.

It should also be understood that the techniques of the present invention might be implemented using a variety of technologies. For example, the methods described herein may be implemented in software running on a computer system, or implemented in hardware utilizing one or more processors and logic (hardware and/or software) for performing operations of the method, application specific integrated circuits, programmable logic devices such as Field Programmable Gate Arrays (FPGAs), and/or various combinations thereof. In one illustrative approach, methods described herein may be implemented by a series of computer executable instructions residing on a storage medium such as a physical (e.g., non-transitory) computer readable medium. In addition, although specific embodiments of the invention may employ object oriented software programming concepts, the invention is not so limited and is easily adapted to employ other forms of directing the operation of a computer.

The invention can also be provided in the form of a computer program product comprising a computer readable storage or signal medium having computer code thereon, which may be executed by a computing device (e.g., a processor) and/or system. A computer readable storage medium can include any medium capable of storing computer code thereon for use by a computing device or system, including optical media such as read only and writeable CD and DVD, magnetic memory or medium (e.g., hard disk drive, tape), semiconductor memory (e.g., FLASH memory and other portable memory cards, etc.), firmware encoded in a chip, etc.

A computer readable signal medium is one that does not fit within the aforementioned storage medium class. For example, illustrative computer readable signal media communicate or otherwise transfer transitory signals within a system, between systems e.g., via a physical or virtual network, etc.

FIG. 2 illustrates an architecture 200, in accordance with one embodiment. As an option, the present architecture 200 may be implemented in conjunction with features from any other embodiment listed herein, such as those described with reference to the other FIGS. Of course, however, such architecture 200 and others presented herein may be used in various applications and/or in permutations which may or may not be specifically described in the illustrative embodiments listed herein. Further, the architecture 200 presented herein may be used in any desired environment.

As shown in FIG. 2, a plurality of remote networks 202 are provided including a first remote network 204 and a second remote network 206. A gateway 201 may be coupled between the remote networks 202 and a proximate network 208. In the context of the present network architecture 200, the networks 204, 206 may each take any form including, but not limited to a LAN, a WAN such as the Internet, public switched telephone network (PSTN), internal telephone network, etc.

In use, the gateway 201 serves as an entrance point from the remote networks 202 to the proximate network 208. As such, the gateway 201 may function as a router, which is capable of directing a given packet of data that arrives at the gateway 201, and a switch, which furnishes the actual path in and out of the gateway 201 for a given packet.

Further included is at least one data server 214 coupled to the proximate network 208, and which is accessible from the remote networks 202 via the gateway 201. It should be noted that the data server(s) 214 may include any type of computing device/groupware. Coupled to each data server 214 is a plurality of user devices 216. Such user devices 216 may include a desktop computer, laptop computer, hand-held computer, printer or any other type of logic. It should be noted that a user device 211 may also be directly coupled to any of the networks, in one embodiment.

A peripheral 220 or series of peripherals 220, e.g. facsimile machines, printers, networked storage units, etc., may be coupled to one or more of the networks 204, 206, 208. It should be noted that databases, servers, and/or additional components may be utilized with, or integrated into, any type of network element coupled to the networks 204, 206, 208. In the context of the present description, a network element may refer to any component of a network.

According to some approaches, methods and systems described herein may be implemented with and/or on virtual systems and/or systems which emulate one or more other systems, such as a UNIX system which emulates a MAC OS environment, a UNIX system which virtually hosts a MICROSOFT WINDOWS environment, a MICROSOFT WINDOWS system which emulates a MAC OS environment, etc. This virtualization and/or emulation may be enhanced through the use of VMWARE software, in some embodiments.

In more approaches, one or more networks 204, 206, 208, may represent a cluster of systems commonly referred to as a “cloud.” In cloud computing, shared resources, such as processing power, peripherals, software, data processing and/or storage, servers, etc., are provided to any system in the cloud, preferably in an on-demand relationship, thereby allowing access and distribution of services across many computing systems. Cloud computing typically involves an Internet or other high speed connection (e.g., 4G LTE, fiber optic, etc.) between the systems operating in the cloud, but other techniques of connecting the systems may also be used.

FIG. 3 shows a representative hardware environment associated with a user device 216 and/or server 214 of FIG. 2, in accordance with one embodiment. Such figure illustrates a typical hardware configuration of a workstation having a central processing unit 310, such as a microprocessor, and a number of other units interconnected via a system bus 312.

The workstation shown in FIG. 3 includes a Random Access Memory (RAM) 314, Read Only Memory (ROM) 316, and I/O adapter 318 for connecting peripheral devices such as disk storage units 320 to the bus 312, a user interface adapter 322 for connecting a keyboard 324, a mouse 326, a speaker 328, a microphone 332, and/or other user interface devices such as a touch screen and a digital camera (not shown) to the bus 312, communication adapter 334 for connecting the workstation to a communication network 335 (e.g., a data processing network) and a display adapter 336 for connecting the bus 312 to a display device 338.

The workstation may have resident thereon an operating system such as the Microsoft WINDOWS Operating System (OS), a MAC OS, a UNIX OS, etc. It will be appreciated that a preferred embodiment may also be implemented on platforms and operating systems other than those mentioned. A preferred embodiment may be written using Python, JavaScript, JAVA, XML, C, and/or C++ language, or other programming languages, along with an object oriented programming methodology or functional programming methodology, or a combination of such methods. Object oriented programming (OOP), and functional programming have become increasingly used to develop complex applications, may be used.

Moreover, a system according to various embodiments may include a processor and logic integrated with and/or executable by the processor, the logic being configured to perform one or more of the process steps recited herein. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

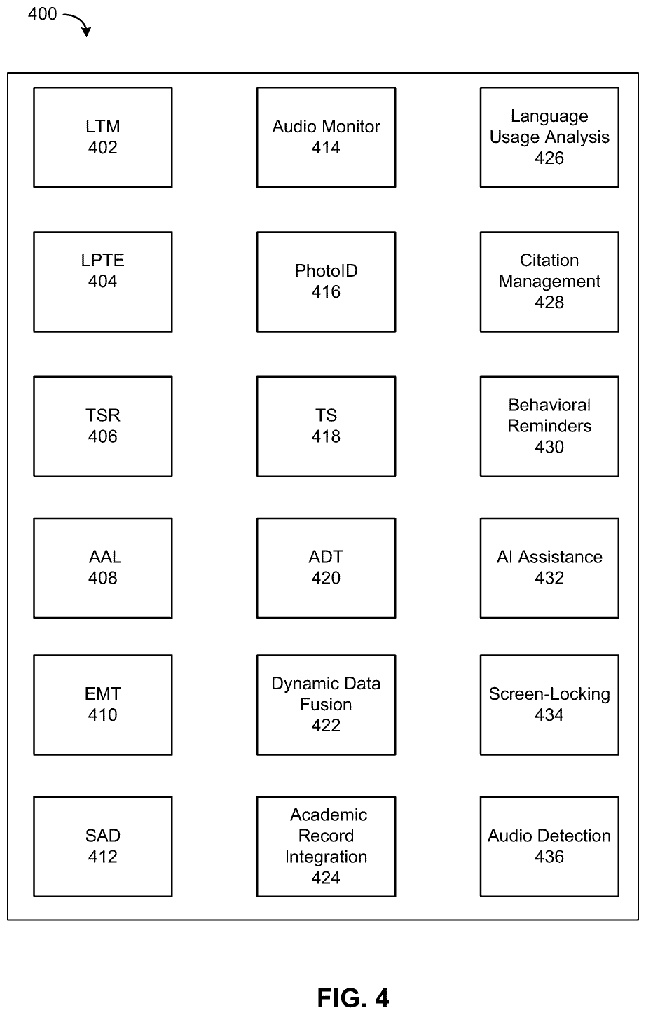

FIG. 4 depicts a system 400, in accordance with one embodiment. As an option, the present system may be implemented in conjunction with features from any other embodiment listed herein, such as those described with reference to the other FIGS. Of course, however, such system and others presented herein may be used in various applications and/or in permutations which may or may not be specifically described in the illustrative embodiments listed herein. Further, the system presented herein may be used in any desired environment.

As shown, the system 400 includes components described above, only some

of which may be present in various embodiments. The components shown include: LTM 402, PTE 404, TSR 406, AAL 408, EMT 410, SAD 412, Audio Monitor 414, PhotoID 416, TS 418, ADT 420, Dynamic Data Fusion 422, Academic Record Integration 424, Language Usage Analysis 426, Citation Management 428, Behavioral Reminders 430, AI Assistance 432, Screen-Locking 434, and Audio Detection 436.

The inventive concepts disclosed herein have been presented by way of example to illustrate the myriad features thereof in a plurality of illustrative scenarios, embodiments, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

The inventive concepts disclosed herein have been presented by way of example to illustrate the myriad features thereof in a plurality of illustrative scenarios, embodiments, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A method for automated online proctoring, the method comprising:
using an AI system to consider monitored aspects of activities of a student taking a test to calculate a trust score indicative of academic integrity, the aspects including at least user interaction with one or more input devices, and eye movements of the student; and
using the AI system to provide guidance to the student during the test for improving a submission input by the student during the test.

2. The method of claim 1, wherein the AI system monitors acoustic data of a test-taking environment to detect indication that the student is receiving guidance from a source of audio information.

3. The method of claim 1, wherein the AI system performs linguistic analysis on the submission to evaluate a coherence and quality of written content in the submission, and provides real-time feedback for improving the submission to the student.

4. The method of claim 1, comprising: using facial recognition software to identify a student; and screen-locking output to a computer screen to prevent the student from using material outside a test display.

5. The method of claim 1, comprising analyzing academic records of the student for generating personalized recommendations to educators, based on a historical performance and writing proficiency of the student.

6. The method of claim 1, wherein the guidance includes suggestions for language formulation and how to improve a structure and content of the submission.

7. The method of claim 1, wherein the AI system observes construction of the student's submission during the test, and tracks an evolution of the submission over time to determine whether the submission appears to be transcribed or copied from an alternate source.

8. The method of claim 1, comprising:
detecting a reference to external material in the student's input during the test;
in response to detecting the reference, outputting a prompt requesting a source URL of the reference; and
generating a citation in a standardized citation format based on information derived using the URL.

9. The method of claim 1, comprising using the AI system to provide a behavioral reminder encouraging ethical writing practice.

10. The method of claim 1, comprising providing an interface to a second AI system for output on a display viewed by the student during the test, wherein the interface is configured to receive input from the student for input to the second AI system, wherein results from the second AI system are output to the student.

11. The method of claim 1, comprising:
tracking eye movements for detecting when the student consults an information source outside of the test display,
wherein the AI system considers a plurality of monitored aspects of activities of the student, including at least typing and the eye movements, to calculate a trust score that characterizes an authenticity and originality of a submission by the student during the test.

12. An automated online proctoring system, comprising
a facial recognition module configured to identify a human student;
a lockdown test monitor module for preventing the student from viewing material outside of a test display during a test; and
an AI system configured to consider a plurality of monitored aspects of activities of the student, including at least typing and eye movements, to calculate a trust score that characterizes an authenticity and originality of a submission by the student during the test,
the AI system also being configured to provide guidance to the student during the test for improving a submission input by the student during the test.

13. The system of claim 12, wherein the AI system is configured to monitor acoustics of a test-taking environment to detect indication that the student is receiving guidance from a source of audio information.

14. The system of claim 12, wherein the AI system performs linguistic analysis on the submission to evaluate a coherence and quality of written content in the submission, and provides real-time feedback for improving the submission to the student.

15. The system of claim 12, wherein the AI system is configured to analyze academic records of the student for generating personalized recommendations to educators, based on a historical performance and writing proficiency of the student.

16. The system of claim 12, wherein the guidance includes suggestions for language formulation and how to improve a structure and content of the submission.

17. The system of claim 12, wherein the AI system observes construction of the student's submission during the test, and tracks an evolution of the submission over time to determine whether the submission appears to be transcribed or copied from an alternate source.

18. The system of claim 12, comprising:
logic for detecting a reference to external material in the student's input during the test;
logic for, in response to detecting the reference, outputting a prompt requesting a source URL of the reference; and
logic for generating a citation in a standardized citation format based on information derived using the URL.

19. A computer program product comprising:
a computer readable storage medium having stored thereon program instructions for causing a computer to perform a method comprising:
using an AI system to consider monitored aspects of activities of a student taking a test to calculate a trust score indicative of academic integrity, the aspects including at least user interaction with one or more input devices, and eye movements of the student; and
using the AI system to provide guidance to the student during the test for improving a submission input by the student during the test.

20. The system of claim 19, wherein the AI system performs linguistic analysis on the submission to evaluate a coherence and quality of written content in the submission, and provides real-time feedback for improving the submission to the student.
